(19) United States
(12) Patent Application Publication
(10) Pub. No.: US 2003/0014465 A1
(43) Pub. Date: Jan. 16, 2003

(54) True distributed control

(76) Inventors: Antonio Mugica, Boca Raton, FL (US); Carlos Alonso, Caracas (VE); Roger Pinate, Caracas (VE); Paul Babic, Caracas (VE); Roberto Ponticelli, Caracas (VE); Oscar Mora, Caracas (VE); Jonathan Bartolotta, Antonio de Los Altos (VE)

Correspondence Address: JEFFREY FURR, 253 N. MAIN STREET, JOHNSTOWN, OH, 43031, US

(21) Appl. No.: 09/682,059

(22) Filed: Jul. 16, 2001

(51) Int. Cl. G06F 9/00; G06F 15/16

(52) U.S. Cl. 709/102; 709/201

(57) ABSTRACT

The present invention introduces a novel and comprehensive method that can be justly called TRUE distributed control (TRUE-DC). This paradigm or method is based on a thorough understanding of real industry needs, and of the theory behind distributed control systems (i.e., the idea of distributed control). It encloses, supplements and/or corrects existing distributed control methods and concepts by introducing a new and real distributed control model based on distributed logic, redundancy and security.

### BACKGROUND OF INVENTION

This invention relates to distributed control systems and methods, specifically to autonomous, nonhierarchical, truly distributed control systems and methods.

### BACKGROUND DISCUSSION OF PRIOR ART

In the past, the term “distributed control” has been used to define and describe numerous different approaches to control systems and methods. In consequence, “distributed control” has become a very vague concept. According to the process control industry, distributed control systems (DCSs) comprise numerous central controllers spread across a plant and interconnected by a high-level network. Every central controller controls devices (e.g., local and remote, and intelligent and dumb) through its input and outputs ports. During the last decade, there has been an industry war to establish a unique standard control bus and control protocol. This war, however, has not ended and, as of this writing, a clear winner is not foreseeable. The result, in general, has been to slightly extend the concept of DCSs stating that a distributed control system should bring system intelligence and communication capability to the transducer or controlled device itself. This usually results in a broader application concept that takes into account all segments of industrial automation applications. This more recent definition, thus, favors the non-hierarchical network architecture, yet it does not require it. It has evolved as the consequence of both real industry needs and the infamous control protocol war. Some of these network protocols have become very complex and may provide better means to slightly approach what can be called “the idea of distributed control”. As a third definition, according to popular belief and misunderstanding, some master/slave control architectures are commonly referred to as distributed control systems. This scheme comprises a master controller and a number of slave controllers connected to their master over some type of bus or simple-network. In general, these schemes provide no network services at all. The most common systems comprise a master controller continuously polling its slaves for communication messages and/or data. Frequently, the slave controllers are very dumb and cannot do much independently of their master controller. The master/slave architecture involves a high degree of hierarchy (i.e., between master and slaves), which is one antithesis of distributed control.

While the preceding definitions may be useful for some specific and/or simple system solutions, they are severely limited in application, cannot be used to implement truly distributed systems and/or cannot even be justly called distributed control systems. These definitions lack a comprehensive set of logic rules defining communication between controllers, thus making intelligent controller interaction highly unfeasible. In addition, they do not solve the question of what to do when a controller fails. Systems implemented according to these definitions do not generally implement controller redundancy and are not fault-tolerant. Finally, there is no mention of security. In a world where communication systems are growing at an exponential rate, the issue of communicating securely is of utmost importance. A true distributed control system must be capable of providing secure communication protocols, authentication and encryption, and guaranteeing data security.

Hence, it is an object of the present invention to overcome the disadvantages of the prior art, and to present a novel and comprehensive method of distributed control closest to the idea of distributed control. This novel paradigm meets real industry needs, and encloses, expands on and/or corrects all previous attempts at distributed control methods and definitions, and may be used to implement real-world systems, regardless of their simplicity or complexity. This new paradigm we call TRUE distributed control.

### SUMMARY OF INVENTION

The present invention introduces a novel and comprehensive method that can be justly called TRUE distributed control (TRUE-DC). This paradigm or method is based on a thorough understanding of real industry needs, and of the theory behind distributed control systems (i.e., the idea of distributed control). It encloses, supplements and/or corrects existing distributed control methods and concepts by introducing a new and real distributed control model based on distributed logic, redundancy and security.

### OBJECTS AND ADVANTAGES OF THE INVENTION

Accordingly, several objects and advantages of the present invention are:

a)To disclose a novel method or paradigm, called TRUE distributed control (TRUE-DC), which corrects common existing distributed control concepts, e.g., why many supposedly “distributed” control systems are not “distributed”

b)To disclose a comprehensive method, called TRUE distributed control (TRUE-DC), which encloses previous and partially correct (though severely limited) methods which have approximated a real implementation of the idea of distributed control;

c)To disclose a comprehensive method, called TRUE distributed control, which introduces definitive solutions to limitations of existing distributed control methods and systems, thus filling in the gaps of existing systems, and extending and completing distributed control methods and concepts;

d)To present the “idea” of distributed control;

e)To present a TRUE distributed control method (TRUE-DC) designed and applied to produce a consistent framework to follow faithfully the “idea” of distributed control, both embracing and transcending all previous methods and definitions;

f)To disclose how a TRUE distributed control method may be implemented as a direct combination of four components, namely, distributed control logic, fault tolerance, security and distributed control;

g)To demonstrate the need for and disclose a method to implement distributed control logic, i.e., a systematic set of rules appropriately defining all possible interactions among control nodes in a TRUE distributed control network system;

h)To demonstrate the need for and disclose a method to implement a peer-based fault resolution scheme to achieve fault-tolerance in TRUE distributed control systems;

i)To demonstrate the need for guaranteeing security both in terms of system integrity and data integrity in TRUE distributed control systems.

Other objects and advantages of this invention will become apparent from a consideration of the ensuing description and drawings.

### DETAILED DESCRIPTION

According to the Merriam-Webster Dictionary, “to distribute” implies an apportioning by separation of something into parts or units, and, hence, the term “distributed” applies to something that is divided into parts or units. “Control” refers to exercising a directing influence over something. Both terms involve a “something”, that is, an object. In “distributed control”, let said object be a task to be performed. Loyal to the classic rule of “divide and conquer”, distributed control divides a task into parts or work units (a.k.a., subtasks). These subtasks are then carried out by operating control units capable of fulfilling them. Thus, the object of every control unit is to carry out and complete its subtask(s) in an orderly and timely fashion.

Accordingly, the “idea” of distributed control involves a complex control system comprising several control units smart enough to act independently, communicate with other units and work together as a team.

These tasks must be performed as a result of each unit″s inputs, the communication among the units, and a set of “social” rules, without requiring the control or supervision of a main or central controller.

True distributed control systems are natural, organic processes. A great example of a true distributed control system is a collection of human beings driving to work every morning. Every driver is a node in the control network. Everyone is independently acting and making decisions (i.e., generating output) based upon:—Every driver″s destination (i.e., each control unit″s program and parameters);—A set of traffic laws, regulations and recommendations (i.e., a set of “social” rules);—The feedback every driver receives from the environment (i.e., input signals) or from other drivers (i.e., communication messages). Thanks to these directives, all drivers can successfully reach their offices every morning. True distributed control systems, just as natural processes, are very complex and must be self-maintaining.

True distributed control systems are very difficult to model computationally and even harder to implement using a consistent framework. Previous attempts at implementing distributed control systems have invariably resulted in limited systems that do not fully implement distributed control. Consequently, no existing so-called “distributed” control systems can be justly called “distributed”. The reasons follow.

There is the common misconception that some master/slave, hierarchical control systems are distributed control systems (e.g., a control network comprising several master controllers with associated slaves). This could not be farther from the truth. As stated above, in a truly distributed system all control units must be capable of working independently of all other units. In a master/slave system arrangement, however, slaves are generally dumb devices that cannot act without being ordered by their masters. In addition, the master/slave control architecture involves a high degree of hierarchy (i.e., between master and slaves) and dependency. If a master unit failed due to physical malfunction or other reason, all its slave control units would fail, and the tasks performed by these would remain unfinished. Perhaps, the only arguable distributed aspect of these systems is that, in some cases, the control system comprises geographically distributed master controllers interconnected by a high-level network.

Next, there are a few implementations of alleged distributed control systems, which dispose of the archaic concept of master/slave architectures. This is already a huge evolutionary step in control methods. These systems are the first attempt to approach distributed control and are the result of the aforementioned control protocol war. These systems comprise control devices that may communicate among themselves, exchange information (though in a limited fashion), and that can operate with some independence, in a distributed fashion, since there are no master controllers.

The main focus in the development of these systems was to do away with centralized control. Hence, they implemented ample and more open network communication protocols, which permit adequate and direct communication between network controllers based on intercontroller messaging, offering more sophisticated network services and addressing. Thus, the need network device polling and other historical artifacts were eliminated.

Though a decent effort to make more open control methods and systems possible, and notwithstanding all the advantages beyond centralized control that these systems provide, they do not lay the foundations on which truly distributed control may be based, and lack a comprehensive understanding of what is needed to achieve true distributed control.

In the above of truly distributed control systems, it was said that they must satisfy three basic requirements: capability to perform independent actions and decisions, capability to communicate among them, and a set of social rules influencing and determining interaction and individual behavior. These new so-called distributed control systems do in many cases implement network controllers that satisfy the first two requirements. However, either they do not at all implement said “social rules”, or they implement them in a very limited fashion (e.g., in the form of control network variables which may be shared among all controllers in a network). This set of “social rules”, as will be seen below, is a fundamental ground for truly distributed control. At best, these systems may be called partially distributed control systems, since they lack distributed logic and true fault tolerance (see below).

Our TRUE distributed control method was designed to produce a consistent framework according to the “idea” of distributed control systems, at once embracing and transcending all previous correct definitions and implementation methods.

The fundamental formula for TRUE distributed control is the amalgamation of four mutually exclusive components, namely, distributed logic, fault tolerance, security and distributed control. Any system not appropriately comprising these four components cannot be considered a true distributed control system.

Next, each of these is described in detail.

Distributed control: A true distributed control system must evidently perform distributed control. Let there be a nonhierarchical control system comprising several interconnected control units, each performing specific, and possibly mutually exclusive, tasks that derive from a larger and more complex task or process. Such control system is said to be distributed if and only if the task being performed by a specific control unit A may continue to be performed even when control unit A fails to operate (see Fault Tolerance below). This implies that tasks must be divided and distributed among control units in the network: when one control unit can no longer perform a task, the task must be automatically and efficiently inherited by a different, operative control unit that may fulfill it, if applicable.

In case no other network control unit may perform the task associated with control unit A (i.e., control unit A is logically irreplaceable), said incomplete task, as a rule, must not cause failure of the complete system. Thus, failure of one control unit does not entail failure of the entire system, and only the task associated with the inoperative control unit may remain unfulfilled.

A true distributed control system executes a process or task, be it simple or complex. The complexity of the task determines the complexity of the system. That is, complex tasks may be divided into a set of simpler subtasks, and each of these may be divided into even simpler subtasks, etc. The result is a set of subtasks that must be performed to carry out the main task. Each of these subtasks may be adopted by a control unit. Depending on the processing capabilities of the control unit, the adopted subtasks may be more or less complex. A control unit may adopt more than one subtask for processing. In addition, as explained below, control units may be logically defined to perform any specific subtask, regardless of its complexity.

Since a true distributed control system comprises no master controllers, there is no one controller directing other controllers, or assigning other controllers the tasks they must execute. Quite the contrary, since the intelligence of the system (i.e., distributed logic) resides distributedly across the control network, not residing in any one controller but in a logical meta-level created by the sum of all distributed controllers, each control unit “adopts” the pending task that is most suitable for its processing capabilities. “Task adoption” is the direct consequence of a consensus among all distributed control units. Thus, the operation of a true distributed control system represents a great deal more than the sum of its operating parts.

Distributed logic: This refers to a collection of rules implicit in a group of control devices that describe and determine all possible semantic relations that may exist between any two or more said devices. Distributed logic is “distributed” because it does not reside in any one of the interconnected devices in the group, but is “spread” among all devices. Let there be a TRUE-DC logical organizational unit called “logic control unit” (LCU). A logic control unit is primarily composed of one or more control devices grouped together to enable them to perform a task more efficiently.

LCUs are essential to distributed logic. All the following are attributes of LCUs:—The fundamental attribute of LCUs is “unity”. Explicitly, to an outside viewer (i.e., to another control device or unit logically residing outside a logic control unit X), said logic control unit X appears as a logically indivisible entity that transparently performs its chores as if it were a single control device.

An LCU may comprise a single control device.-Several basic control devices may be clustered together to produce an LCU: the result may be an LCU with far more processing power capabilities.

An LCU may enclose other LCUs. Each enclosed LCU is treated as if it were a single control device. Thus, there may be complex LCUs, created out of simpler LCUs, and so on, recursively, until the level in which LCUs consist of single control devices. Recursion (i.e., LCUs enclosed inside other LCUs, etc) is possible, but not required.—A control device, according to and depending upon its processing power and characteristics, may belong to one or more LCUs, if applicable.

LCUs may be logically formed between any devices grouped together to carry out a task, independently of geographical location, communication and network protocols and media, etc. All underlying control devices may be interconnected. The collection of individual control devices into an LCU occurs at a logical level.

All control devices grouped into a logic control unit have equal hierarchy, i.e., any one device may request information from or supply information to any other device. This applies equally to LCUs: all LCUs stand at an identical hierarchy level, possess equivalent rights and responsibilities towards each other and may freely communicate amongst them. There is no notion of hierarchy in true distributed control. A true distributed control system, thus, comprises a logical association of LCUs. In fact, a true distributed control system is itself an LCU. That is, it encompasses several interconnected LCUs arranged in a logical network.

As a true distributed control system is created from a combination of LCUs, a set of social rules describing all possible types of interactions between these must be established. This set of rules may include both global rules, which all system LCUs must follow, and local rules, which specific system LCUs must follow. Both global and local rules may vary from system to system. In addition, a set of universal rules, which apply to all LCUs regardless of the system these operate in, may also be established. Each LCU only possesses knowledge of the subset of rules that apply to it, and may not necessarily contain information about other rules applicable to other LCUs.

Every individual LCU must strictly follow all rules that apply to itself and its relationships with other LCUs. Consequently, no system LCU has power to operate freely, i.e., independently of its rules. On the contrary, the behavior of every LCU is constrained by the rules that apply to it.

Accordingly, said sets of universal, global and local rules directly influence and determine the behavior of each applicable LCU. Hence, as several LCUs operate concurrently, the behavior of each of them derives from its own set of applicable rules in dynamic relationship with the rules that apply to other LCUs with which it interacts. Thus, as LCUs act and interact, a higher order of dynamic operating rules develops automatically and inevitably from the concurrent operation of said universal, global and local rules in all interacting system LCUs.

The highly dynamic system behavior resulting from the LCU-level enforcement of universal, global and local rules, therefore, constitutes “distributed logic”. As distributed logic results from dynamic interrelations among LCUs and their individual governing rules, it does not reside in any one specific LCU. Quite the opposite, it resides in a composite and dynamic logic meta-level that springs from such interrelations. Distributed logic is the distributed brain of a TRUE-DC system, i.e., where the intelligence of the system lies. Although each LCU″s rules apparently restrict its utilization and performance, the ultimate goal is the optimization of overall system performance and not of specific parts of it. Optimizing the operation of individual LCUs (i.e., local optimization) does not necessarily result in optimization of the overall operation of the system (i.e., global optimization). In fact, local optimizations may sometimes have a severe negative impact in the overall system operation. Thus, the rules that govern the activity of specific LCUs and the interaction among them must sustain global optimization as the principal goal.

Distributed logic appears to consist of two ingredients, if viewed from a control unit point of view. Logic control unit X observes, first, the interaction among all its constituent parts and, second, its interaction as a unit with other outside LCUs. (Again, to an outside unit, logic control unit X performs as an indivisible whole.) Nonetheless, since a control unit comprises a set of interrelated simpler control units, it follows that these two types of interactions are of one same order or nature.

Let us return to the example of people driving to work every morning. There is a set of “social rules” that every driver must respect to ensure safe and correct results. These “social rules” comprise a comprehensive set of traffic laws, rules and regulations, including universal, global and local rules. A universal rule may be that all drivers must stop at red traffic lights, and may drive on once they switch to green light. A global rule for people driving in the U.S.A. is that drivers must always drive on the right lanes (conversely, a similar implementation in Great Britain requires that all drivers drive on the left lane). A local rule, i.e., that only applies to specific drivers, may be that trucks larger than a specific size may only circulate in certain roads. A rule that applies to the interaction between several drivers may be that transit system buses have priority over regular vehicles, and thus regular vehicle drivers must yield to buses when these drive out of bus stops. In addition, not every driver needs to know the rules that apply to all other drivers. For instance, bicycle drivers that drive on dedicated bicycle paths need not know of rules that apply to truck drivers that drive on interstate highways.

Once these sets of rules have been defined and learned, everyone leaves home and drives to work. Once on the road, every driver follows his or her own applicable laws, stopping at red traffic lights, yielding to buses, etc. If rules have been correctly designed to prevent collisions and every driver faithfully follows his or her applicable rules, collisions cannot occur. The dynamic behavior of this natural distributed system as a result of the dynamic interaction of rules applicable to system components is what constitutes distributed logic.

In existing so-called distributed control systems, system logic is not distributed. Their alleged intelligence is founded on simple or complex number-crunching algorithms (e.g., IF THEN ELSE-type algorithms) residing and executing on single control devices. Their implementation is tightly associated with their assigned task. Hence, they cannot be justly called intelligent systems.

In contrast, TRUE-DC defines LCUs, the relations among them, their inputs and outputs, and algorithms to perform the system task, independently of individual control devices. As a result, there is no fixed IF THEN ELSE-algorithm executing on a given control device. Rather, an LCU may dynamically obtain its inputs from other LCUs, an LCU output or other information may be transferred to other LCUs that may require them, etc. Thus, intelligence derives from a set of simple algorithms (e.g., IF THEN ELSE) that are not inbuilt or inherent to any specific device but that exist as a result of the relationship among all LCUs.

Fault Tolerance: In all existing distributed control systems, close relationships are generally established among system components, and any control unit may depend on one or more other units. For instance, a distributed control network may include a controller responsible for checking the ON/OFF state of an element of the controlled process and for the propagation of said information to other network controllers. In this common example, failure of the provider unit (i.e., sensing controller) affects all units that depend on it. In several existing systems, failure of a component results in failure of the entire system.Accordingly, there are two fundamental aspects to fault tolerance in TRUE distributed control systems. The first relates to automatic detection of faulty system components (e.g., peer-based fault detection). The second relates to automatic substitution of faulty system components (e.g., Automatic Control Redistribution). TRUE-DC involves the use of a mechanism for the automatic detection of failure in any distributed system components. In existing systems, this is achieved using a dedicated, central monitoring device that periodically checks on the status of all control units and generates reports in case malfunctioning components are detected. TRUE-DC recognizes that this is a possible solution to the problem. Nonetheless, the nature of this solution violates the principles of true distributed control, since it involves a central device with assigned responsibilities. Thus, failure of the central monitoring device may preclude control unit fault detection.

TRUE-DC proposes a better solution: a peer-based approach to fault detection in which the fault-monitoring task is dynamically distributed among all control units in the network. Once failure in a control system component has been detected (i.e., a controller is malfunctioning or totally inoperative), a true distributed control system must find a method to “substitute” the faulty component so that the component″s adopted subtasks are handled.

Some existing distributed control systems achieve a high degree of fault tolerance through redundancy. Redundancy implies the utilization of duplicate control units (a.k.a., secondary equipment) to provide alternative control when primary equipment fails. While TRUE-DC recognizes redundancy as an important step towards fault-tolerance, redundancy entails a significant, undesirable increase in system implementation costs. (The Webster″s Unabridged Dictionary defines “redundancy” as “the quality or state of being superfluous, unneeded, an excess”.) In addition, redundancy seems like an unintelligent approach if one considers that there is nothing to be done once secondary equipment fails, other than implement ternary equipment, and so on, ad infinitum.

True fault tolerance requires a comprehensive scheme for both automatic distributed detection of failure in TRUE-DC system components, and virtual control unit replacement (also called virtual redundancy). Accordingly, an approach compatible with the idea of distributed control is that of Automatic Control Redistribution (ACR). Through ACR, the faulty component″s subtasks are automatically and efficiently adopted by other control units in the system capable of performing and fulfilling them. In the preferred embodiment, ACR comprises the following steps. In the first place, the faulty controller is advised to suspend operation, and so is relieved of its subtasks. Next, it is reported as faulty to the entire control system (i.e., in case of peer-based fault detection, this is done by the faulty controller″s peer). The report includes a description of the device and the subtasks for which it was responsible. Next, other system controllers capable of adopting the faulty component″s subtasks publish their desire to adopt them. Next, if possible, the faulty component must transfer its current subtask state information to one controller willing to “adopt” its subtasks (i.e., adopting controller). Then, the adopting controller continues performing the faulty controller″s subtasks. Otherwise, the subtask must be restarted by the adopting controller.

The above procedure requires that the faulty controller″s peer have knowledge of the subtasks being performed by its peer (i.e., in case the faulty controller is totally inoperative or unable to transfer subtask information to the adopting controller, the faulty controller″s peer must provide it). Following the above method accomplishes “virtual redundancy”. In case of control component failure, control of subtasks is redistributed among the remaining operating control system components. This results in a system that is highly fault-tolerant without the cost penalty associated with the physical redundant approach. Fault tolerance, however, will always have a limiting factor in the system″s physical implementation.

Security: No existing distributed control system implements methods to establish secure control networks. As the world moves quickly towards the state of total interconnectivity, the need for secure communication systems and the need for data security have abruptly increased. Security comprises any systematic approach used to protect both the integrity of the data that travels across control networks and the physical integrity of the control system.

To protect the integrity of the data that travels through the control network, one of several existing secure communication protocols implementing data encryption must be used. To protect the physical integrity of the control system, exhaustive controller authentication must be performed to ensure that received messages are indeed received from genuine and allowed control units.

### CONCLUSION, RAMIFICATIONS, AND SCOPE OF THE INVENTION

Thus, the reader will see that the present method or paradigm of TRUE distributed control corrects wrong misconceptions, and encloses and significantly expands on partially correct existing conceptions of distributed control, eliminating many of their limitations. The present method″s most significant contribution is the integration of four essential components, namely, distributed control, distributed logic, fault tolerance and security, that together result in a method to implement TRUE distributed control. The present method approaches the idea of distributed control like no other existing method.

While our above description contains many specificities, these should not be construed as limitations to the scope of the invention, but rather as an exemplification of one preferred embodiment thereof. Obviously, modifications and alterations will occur to others upon a reading and understanding of this specification such as, for example, that it may be desirable that the entire true distributed control system stops operation, partially or totally, once failure in a system component has been detected. In addition, by defining appropriate LCUs and relationships between them, true distributed control systems may be designed to implement traditional distributed control systems, or even systems based on master/slave architectures.

the description above is intended, however, to include all such modifications and alterations insofar as they come within the scope of the appended claims or the equivalents thereof.

What is claimed is:

1. A control system comprising: Having the following,four components; i) distributed logic, ii)fault tolerance, iii)security, and iv)distributed control; and A plurlarity of interconnnected control units.

2. A control system in claim 1 further comprising said components being mutually exclusive.

3. A control system in claim 1 further comprising said Distributed control consisting of a plurlarity of interconnected control units, each performing specific task or subtasks.

4. A control system in claim 1 further comprising if one of said control units fails to perform a task or subtask that task or subtask is passed to and executed by another control unit.

5. A control system in claim 1 further comprising said Distributed logic is a set of rules that determine the relations between the control units.

6. A control system in claim 1 further comprising each control unit adopts a pending task or subtask that is most suitable for its processing abilities.

7. A control system in claim 1 further comprising a logical organizational unit consisting of a logic control units with the following attributes; Tasks or subtasks may be performed on a plurlarity of control units as if on a single control unit; May comprise a single control unit; May comprise of a plurlarity of control unit; May enclose other Logical Control Units; A control unit may belong to a plurlarity of Logical Control Units; and All control units in a logic control unit have equal hierarchy.

8. A control system in claim 1 further comprising said Distributed logic is a set of dynamic rules that develop automatically from the operation of said system to determine the relations between the control units.

9. A control system in claim 1 further comprising said fault tolerance consisting of two parts: Detection of faulty system components; and The automatic substitution of faulty system components.

10. A control system in claim 1 further comprising said fault tolerance uses a peer based means for fault detection.

11. A control system in claim 1 further comprising said fault tolerance uses virtual control unit replacement in which: A faulty control unit is told to suspend operation; The faulty control unit is reported as faulty to system; Another control unit capable of executing the faulty control units tasks or subtasks requests to execute them; Said faulty control unit will transfer its current task or subtask to requesting control unit; and Said requesting control unit will execute the tasks or subtasks.

12. A control system in claim 1 further comprising said security consisting of having a secure communication protocols implementing data encryption and controller authentication means

13. A method for a TRUE distributed control sysem, the method comprising the steps of: Having a the following four components; v)distributed logic, vi)fault tolerance, vii)security, and viii)distributed control; and Having a plurlarity of interconnnected control units.

14. The method in claim 13 further comprising said components being mutually exclusive.

15. The method in claim 13 further comprising said Distributed control consisting of a plurlarity of interconnected control units, each performing specific subtasks or tasks.

16. The method in claim 13 further comprising if one of said control units fails to perform a task or subtask that task or subtask is passed to and executed by another control unit.

17. The method in claim 13 further comprising said Distributed logic is a set of rules that determine the relations between the control units.

18. The method in claim 13 further comprising each control unit adopts a pending task or subtask that is most suitable for its processing abilities.

19. The method in claim 13 further comprising having a logical organizational unit consisting of a logic control units with the following attributes; Task or subtask may be performed on a plurlarity of control units as if on a single control unit; May comprise a single control unit;May comprise of a plurlarity of control units; May enclose other Logical Control Units; A control unit may belong to a plurlarity of Logical Control Units; and All control units in a logic control unit have equal hierarchy.

20. The method in claim 13 further comprising said Distributed logic is a set of dynamic rules that deveop automatically from the operation of said system to determine the relations between the control units.

21. The method in claim 13 further comprising said fault tolerance consisting of two parts: Detection of faulty system components; and The automatic substitution of faulty system components.

22. The method in claim 13 further comprising said fault tolerance uses a peer based means for fault detection.

23. The method in claim 13 further comprising said fault tolerance uses virtual control unit replacement in which: A faulty control unit is told to suspend operation; The faulty control unit is reported as faulty to system; Another control unit capable of executing the faulty control units tasks or subtasks requests to execute them; Said faulty control unit will its current task or subtask to requesting control unit; and Requesting control unit will execute the tasks or subtasks.

24. The method in claim 13 further comprising said security consisting of having a secure communication protocols implementing data encryption and having a controller authentication means
